(19) United States
(12) Patent Application Publication
(10) Pub. No.: US 2016/0057087 A1
(43) Pub. Date: Feb. 25, 2016

(54) PROCESSING MEDIA MESSAGES BASED ON THE CAPABILITIES OF THE RECEIVING DEVICE

(71) Applicant: Facebook, Inc., Menlo Park, CA (US)

(72) Inventor: Ryan Jacob Gomba, San Francisco, CA (US)

(21) Appl. No.: 14/465,625

(22) Filed: Aug. 21, 2014

(51) Int. Cl. H04L 12/58; H04L 29/06

(52) U.S. Cl. CPC H04L 51/10; H04L 65/60

(57) ABSTRACT

When a user requests to send a media message to a contact, a sending device retrieves the device parameter of a receiving device used by the contact to receive messages. Based on the retrieved device parameters, the sending device processes a media file to be included with the media message. The sending device processes the media file to reduce the size of the media file and for the media file not to exceed the display capabilities of the receiving device. The sending device sends the media message with the processed media file to the receiving device of the contact via a messaging system.

### BACKGROUND

This invention generally relates to messaging, and in particular to processing media files included in messages based on the capabilities of the device receiving the messages.

Due to the widespread use of mobile devices and advancements in mobile device technology, the sharing of media content (e.g., videos and images) between devices has become very popular. A downside to exchanging media content between devices is that it typically takes an extended period of time to exchange media content due to the large size of the files and the limited bandwidth available for sending the media content. Further, users of certain mobile devices (e.g., mobile phones) have to pay for the amount of data that they use. Therefore, exchanging media content can be costly for users, and it is desirable to avoid wasting bandwidth.

### SUMMARY

In an embodiment of a messaging application that allows users to send media files to their contacts, a recipient of a message is allowed to consume a media file included with the message only on the device at which the message was received. For example, if a user sends a photograph to a recipient, the recipient can view the photograph using the messaging application. But the messaging application does not enable the recipient to save, forward, print, or otherwise consume the photograph outside of the message application or outside of the device that received the media content using the messaging application. As a result, if the transferred media file contains more data than the recipient's device can take advantage of (e.g., a higher resolution image or audio content with higher fidelity than the device can reproduce), the transfer of the media file constitutes a waste of bandwidth. It would thus be desirable to reduce the data required to consume the media file at the recipient's device before sending the media file over a network connection.

In embodiments of a messaging system, a user is able to send media messages that include media files (e.g., image or video files) to the user's contacts. For each of one or more contacts, the user's client device locally stores one or more parameters indicating the capabilities of the contact's device for displaying media files (e.g., the aspect ratio, screen size, pixel resolution, colors available, video playback capabilities, sounds playback capabilities, etc.). When a user requests to send a media message to a contact for which the user's client device (sending device) stores device parameters, the sending device retrieves the contact's device parameters stored for the contact (retrieves the device parameters for the receiving device). In another embodiment, the device parameters of the receiving device are remotely stored by the messaging system and the sending device obtains the device parameters from messaging system. Further, the sending device identifies a media file to include with the media message. The identified media file may have be previously stored on the sending device or captured at the moment for example, using an internal camera and/or microphone.

Before sending the media file with the message, and based on the retrieved device parameters, the sending device processes the media file to reduce the size of the media file. In some embodiments, the processing is selected so that the processed media file does not exceed the capabilities of the receiving device. Processing the media file may include, for example, downscaling and downsampling the media file if the media file is larger than the display capabilities of the receiving client device and if the receiving client device does not support the current resolution of the media file. The processing may also include cropping an image or video file to match the display screen of the receiving device. The processing may also include transcoding the media file using different quantization parameters selected based on the receiving device's capabilities. The sending client device sends the media message with the processed media file to the device of the contact via the messaging system.

Processing the media file based on the device parameters of the receiving device before sending the file allows the sending device to send a media file that the receiving device will be able to display and allows for an efficient exchange of data by only sending data that will be used by the receiving device (e.g., not sending a high resolution file if the receiving device only supports low resolution files). The system is thus optimized to allow messaging where a lower media file resolution at the receiving device is acceptable or desirable in exchange for the ability to send the message more rapidly and efficiently, such as in a messaging system designed to instantly capture and share a moment via picture/video, where the captured media file will be only briefly viewed by the recipient and/or will not be stored at the receiving device.

### BRIEF DESCRIPTION OF THE DRAWINGS

FIG. 1 is a block diagram of a messaging environment, in accordance with an embodiment of the invention.

FIG. 2 is a block diagram illustrating modules operating within a messaging module, in accordance with an embodiment of the invention.

FIG. 3 is a block diagram illustrating modules operating within a messaging system, in accordance with an embodiment of the invention.

FIG. 4 is a diagram illustrating operation performed by a sending device, the messaging system, and a receiving device when sending a media message from the sending device to the receiving device, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Architecture

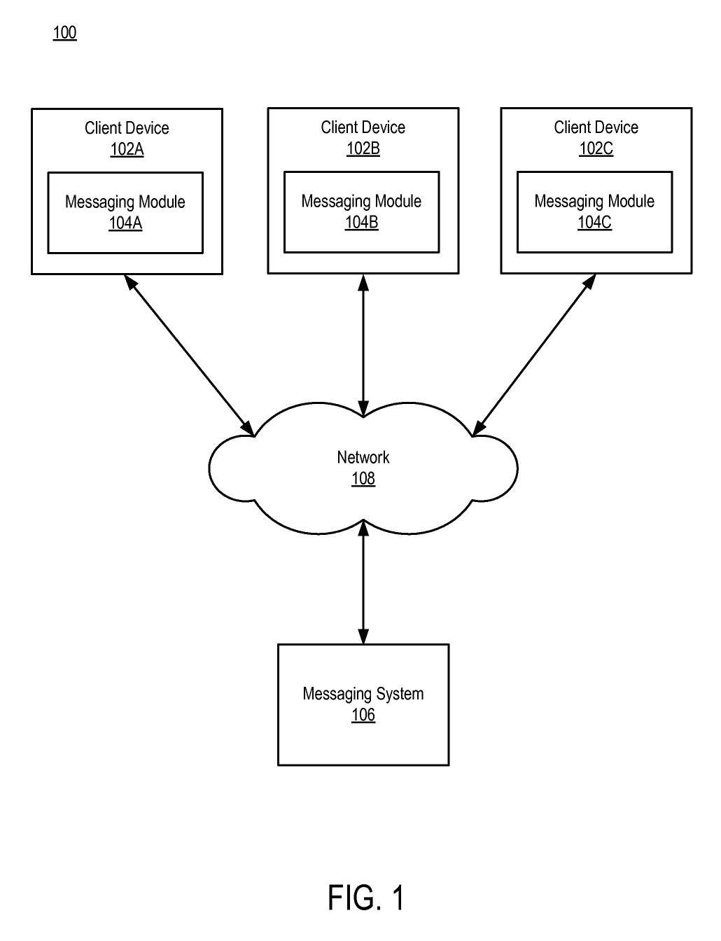

FIG. 1 is a block diagram of a messaging environment 100, in accordance with an embodiment of the invention. The messaging environment 100 shown by FIG. 1 includes client devices 102A, 102B, and 102C, a messaging system 106 and a network 108. Although a select number of each entity are shown in FIG. 1, embodiments can have more or less of each entity (e.g., additional client devices 102).

FIG. 1 and the other figures use like reference numerals to identify like elements. A letter after a reference numeral, such as “102A,” indicates that the text refers specifically to the element having that particular reference numeral. A reference numeral in the text without a following letter, such as “102,” refers to any or all of the elements in the figures bearing that reference numeral (e.g., 102A, 102B, and 102C).

A client device 102 is a computing device capable of receiving user inputs as well as transmitting and/or receiving data via the network 108. In one embodiment, a client device 102 is a mobile device, such as a mobile telephone, a tablet computer, or a personal digital assistant (PDA). Alternatively, a client device 102 may be a conventional computer system, such as a desktop computer. In one embodiment, a client device 102 includes a camera that can create media files, such as video files and image files.

Each client device 102 includes a messaging module 104 that allows users of the messaging system 106 to exchange media messages. A media message is a message that includes one or more media files (e.g., video files or image files). A media file may include one or more of the following types of media content: video content, a still image, audio, text, and animations. Although processes are described herein as being applied to media messages, it should be understood that the same processes can be applied to any type of messages (e.g., messages that do not include media files). In one embodiment, the messaging module 104 is provided to the client devices 102 by the messaging system 106.

A client device's 102 messaging module 104 stores contact information (e.g., a phone number) for each contact of the user operating the client device 102. A contact is a user of the messaging system 106 whose contact information is stored by the messaging module 104. Additionally, for one or more contacts, the messaging module 104 stores device parameters of a client device 102 used by the contact to receive messages. In one embodiment, the messaging module 104 obtains the device parameters from the messaging system 106. In another embodiment, the messaging module 104 communicates with the contact's client device directly to obtain the device parameters. Device parameters are parameters of a client device 102 indicating the device's 102 capabilities for receiving media messages and/or displaying media files (reproducing media content). The stored device parameters of a client device 102 may be, for example, the size of the device's 102 display, the pixel resolution of the device 102, and the average download speeds of the device 102.

When a user of a client device 102 (sending device) requests to transmit a media message to a contact (e.g., a user operating another of the client devices 102, in this case a receiving device), the sending device's messaging module 104 allows the user to identify a media file to include with the media message. For example, the messaging module 104 may allow the user of the sending device's to create a media file by enabling an internal camera for taking a picture or recording a video. If the messaging module 104 has stored device parameters for the receiving device used by the contact to receive media messages, the messaging module 104 retrieves the stored device parameters.

Based on the stored device parameters, the messaging module 104 processes (e.g., scales and compresses) the created media file to reduce the size of the media file. In one embodiment, the media file is processed in such a way that the processed media file can be displayed by the receiving device and does not exceed the maximum capabilities of the receiving device (e.g., does not exceed the display capabilities of the receiving device's display). In another embodiment, the media file is processed to be near the maximum capabilities of the receiving device. Therefore, in this embodiment, the processed media file may be slightly above the maximum capabilities of the receiving device.

The messaging module 104 transmits the processed media file in a media message to the messaging system 106, which forwards the media message to the receiving device. In one embodiment, a message transmitted to a receiving device in the messaging environment 100 is only intended for the receiving device and cannot be shared by the receiving device with any other device. Further, after a media file included with the message is viewed or a set period of time after the file is viewed, the media message and the media file are deleted. Additionally, the media file cannot be saved for later access or printed. Hence, since the messaging module 104 knows which client device 102 will be receiving the media file and that the media file will not be viewed on another device, the messaging module 104 is able to process/customize the file according to the parameters of the receiving device.

As an example, assume the user creates a 720p high resolution video to send to the contact. However, based on the device parameters, the messaging module 104 determines that the maximum resolution that the receiving device can display is a 360p low resolution video. Based on this information, the messaging module 104 may convert the high resolution video file to a 360p video file prior to sending the file to messaging system 106.

By processing a media file at the sending device according to the capabilities of the receiving device, it allows the sending device to only send data that will be used by the receiving device. For example, sending a bigger file than what is needed will not only take longer for the receiving device to receive, but it may also unnecessarily cost the users money if they pay a service provider (e.g., a mobile phone service provider) based on the amount of data exchanged. Continuing with the example from above with regards to the 720p high resolution video file, if the messaging module 104 had sent the high resolution video file to the receiving device instead of the 360p low resolution video file, the receiving device would have had convert the file to at most 360p prior to displaying the video. Hence, the additional data sent by the sending device 102 (the size difference between the high resolution file size and the low resolution file size) would have been wasted.

The messaging system 106 is a computer system that allows users to exchange messages. The messaging system 106 stores contact information for each user that has registered with the messaging system 106 to use the messaging system's 106 services. For one or more users, the messaging system 106 also stores device parameters of the client devices 102 used by the users to receive messages from the messaging system 106. In one embodiment, the messaging system 106 stores device parameters for each user of the messaging system 106. In another embodiment, the messaging system 106 only stores device parameters for users that elect to share their device parameters.

The messaging system 106 shares a user's device parameters with other client devices 102. In one embodiment, the messaging system 106 shares a user's device parameters with client devices 102 where the user is added as a contact. In another embodiment, the messaging system 106 only shares device parameters with client devices 102 that request the device parameters and/or satisfy certain criteria provided by the user. When a user's device parameters change (e.g., a user changes client devices 102), the messaging system 106 provides updated device parameters to client devices 102 that have the outdated device parameters.

When the messaging system 106 receives a media message from a client device 102, the messaging system 106 identifies, in the message, contact information of the intended recipient. Based on the identified contact information, the messaging system 106 forwards the media message to the appropriate client device 102 via the network 108.

The client devices 102 and the messaging system 106 are configured to communicate via the network 108, which may comprise any combination of local area and/or wide area networks, using both wired and/or wireless communication systems. In one embodiment, the network 108 uses standard communications technologies and/or protocols. For example, the network 108 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 108 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 108 may be represented using any suitable format, such as hypertext markup language (HTML) or extensible markup language (XML). In some embodiments, all or some of the communication links of the network 108 may be encrypted using any suitable technique or techniques.

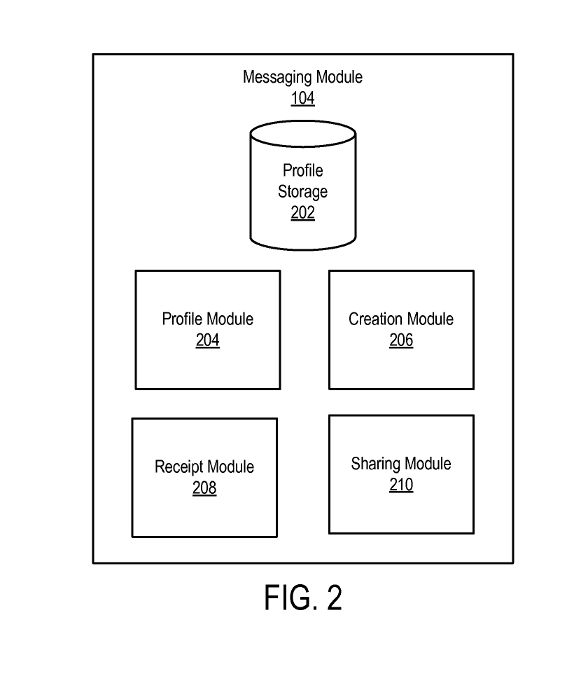

FIG. 2 is a block diagram illustrating modules operating within a messaging module 104 executed by a client device 102. The messaging module 104 shown in FIG. 2 includes a profile storage 202, a profile module 204, a creation module 206, a receipt module 208, and a sharing module 210. In other embodiments, the messaging module 104 may include additional, fewer, or different components for various applications.

The profile storage 202 stores a profile for each contact of the user operating the client device 102. A contact's profile includes contact information, which is information used to communicate with the contact. In one embodiment, the contact information included in a contact's profile is a phone number of the contact. In other embodiments, the contact information included in a contact's profile includes one or more of the following: an email address, a user name, a messaging identifier, and an IP address.

The profiles of one or more contacts include device parameters of the devices 102 used by the contacts to receive messages. In one embodiment, each contact's profile includes device parameters obtained from the messaging system 106. In another embodiment, only the profiles of contacts that elected to share their device parameters with the messaging system 106 include device parameters. Alternatively, profiles that include device parameters are those of contacts that have a certain type of relationship with the user of the client device 102 (e.g., a type of relationship in a social networking system), contacts with which the user frequently exchanges messages (e.g., more than a threshold number of times per time period, such as more than once a day), and/or contacts for which the user has requested that device parameters be stored.

The device parameters stored for a client device 102 in a contact profile may include resolution parameters related to the display of the client device 102. Resolution parameters may include one or more of the following: physical display size, aspect ratio, pixel resolution, pixel density, max brightness, contrast ratio, display colors, and a type of the display (e.g., AMOLED, PMOLED, LCD, etc.). Device parameters may also include network parameters related to the client device's 102 ability to receive media message. Network parameters may include one or more of the following: average download speed, a current network congestion level, and a type of network that the device is currently using for exchanging data (e.g., Wi-Fi, LTE network, WIMAX network). Other device parameters stored for a client device 102 may include one or more of the following: operating system, processor, graphics chip, the amount of available memory, video compression settings, sound playback capabilities, and available codecs.

The profile module 204 manages the profiles stored in the profile storage 204. When the user of the client device 102 requests to add another user as a contact, the profile module 204 creates a profile for the contact in the profile storage 202. The profile module 204 adds to the contact's profile contact information provided by the user. In one embodiment, the profile module 204 also sends a request to the messaging system 106 for device parameters of the client device 102 used by the contact to receive messages. In one embodiment, the profile module 204 only sends a request to the messaging system 106 if the user requested that device parameters be obtained or if the contact has a certain type of relationship with the user. If device parameters for the contact are received from the messaging system 106, the profile module 204 adds the device parameter's to the contact's profile.

When the profile module 204 receives from messaging system 106 updated device parameters for the device 102 of a contact, the profile module 204 identifies the contact's profile in the profile storage 202 and updates the profile to include the updated device parameters. In one embodiment, updates to device parameters are automatically sent by the messaging system 106. In another embodiment, the profile module 204 periodically (e.g., once a day) sends a request to the messaging system 106 for any updated device parameters.

The creation module 206 processes requests to send media messages to contacts. The creation module 206 receives requests from the user of the client device 102 to send media messages to contacts. In one embodiment, the user requests to send a media message to a contact by selecting the contact, for example, from a contact list.

The creation module 206 allows a media file to be captured in various ways for inclusion with the media message. In one embodiment, the messaging system 106 allows quick capture and sharing of a media file (e.g., a photo or video). When selecting the contact, the user also indicates the type of media file that the user wants to include with the media message. In one embodiment, the user indicates the type of media file to include with the media message based on the amount of time the user keeps a finger on device's 102 display when selecting the contact. In one embodiment, when selecting the contact, if the user keeps a finger on the device's 102 display for less than a threshold period of time, it signifies that user would like to include an image file with the media message. On the other hand, if the user keeps a finger on the display for longer than the threshold period of time, it signifies that the user would like to include a video file with the media message. Hence, with one touch of the client device's 102 display, the user can indicate the contact that will receive the media message, the type of media file to include with the message, and as described below can cause the message to be sent once the media file is created and processed. Other embodiments might use two or more touches to send the message, but in any case, the sending device still can process the media file according to the recipient's maximum device capabilities to allow a user to quickly capture and send media content.

When the creation module 206 receives a request from the user to send a media message to a contact, the creation module 206 enables a camera of the client device 102 or the device may already be in camera mode. In one embodiment, based on the received request, the creation module 206 automatically controls the camera. If the request indicates that an image file be included with the media message, the creation module 206 automatically instructs the camera to capture an image. If the request indicates that a video file be created, the creation module 206 instructs the camera to start a video recording and instructs the camera to stop the recording a set amount of time after starting (e.g., 10 seconds after starting). Therefore, in this embodiment, once the user makes the request, the creation module 206 automatically controls the camera and creates the media file. In another embodiment, once the user makes the request and the creation module 206 enables the camera, the user controls the creation of media file by, for example, indicating when to capture an image or indicating when to start and stop a video recording. The media file can also be provided for use in the message in other ways including, for example, retrieving a media file from storage on the device or elsewhere.

Once the media file that is to be included with media message is identified (e.g., created or retrieved), the creation module 206 processes the media file for transmission to the contact's client device 102. Processing the media file may include performing one or more of the following on the media file: scaling, resampling, compressing, cropping, encoding, and transcoding, as well as other well known image and video processing techniques.

To process the media file, the creation module 206 determines whether the contact's profile in the profile storage 202 includes device parameters for the client device 102 of the contact that will receive the media message (also referred to as the “receiving device”). If the contact's profile does not include device parameters, the creation module 206 performs default processing on the media file. The default processing may be, for example, compressing the media file for transmission.

On the other hand, if the contact's profile includes device parameters for the receiving device, the creation module 206 processes the media file based on the device parameters. In one embodiment, prior to processing the media file, the creation module 206 communicates with the messaging system 106 to determine whether the device parameters of the receiving device have changed. In another embodiment, the device parameters are not stored by the client device 102 and the creation module 206 communicates with the messaging system 106 to obtain the device parameters.

Based on the device parameters, the creation module 206 determines the capabilities of the receiving device and processes the media file according to the receiving device's capabilities. The creation module 206 processes the media file to reduce the size of the file based on the capabilities of the receiving device. In one embodiment, the creation module 206 processes the media file to at most meet, but not exceed the maximum capabilities of the receiving device. For example, if a created image is too large for the display of the receiving device, the creation module 206 can downscale the image to the maximum size that the receiving device can display. As another example, if a created video is at a higher resolution than what the receiving device is capable of displaying, the creation module 206 can downsample the video to the maximum resolution that the receiving device is capable of displaying. Further, as another example, if the current download speed of the receiving device is relatively slow, the creation module 206 can compress the created media file to a size that would allow the receiving device to receive the file within a certain period of time.

In another embodiment, the creation module 206 processes the media file to be near the maximum capabilities of the receiving device. Therefore, in this embodiment, the processed media file may be above (e.g., slightly above), at, or below (e.g., slightly below) the maximum capabilities of the receiving device.

In another embodiment, the creation module 206 determines an optimal strategy for processing the media file when taking into account the display capabilities of the receiving device and how quickly the media file will be received by the receiving device. For example, the creation module 206 may process the file to a level that will allow the receiving device to quickly receive the media file but is still reasonable for display on the receiving device in view of its display capabilities. The creation module 206 may give one factor more weight than the other. For example, the creation module 206 may give higher weight to speed than to display quality, while in other situations the creation module 206 may give higher weight to display quality than to speed. In one embodiment, the user of the sending device indicates which factor should be given more weight.

The creation module 206 includes the processed media file with the media message, which also includes the contact's contact information. In one embodiment, the creation module 206 sends the media message to the messaging system 106 so that it can be forwarded to the contact's receiving device. In another embodiment, the creation module 206 sends the media message directly to the contact's receiving device.

The receipt module 208 processes media messages received by the client device 102 executing the messaging module 104. When a media message is received by the client device 102 (e.g., from the messaging system 106), the receipt module 208 identifies the media file included in the media message. The receipt module 208 processes the media file for displaying the media file. Processing the media file may include, for example, decompressing the media file. The receipt module 208 displays the media file on the client device 102. In one embodiment, after the media file is viewed, the receipt module 208 deletes the media file and the media message so that the media file cannot be displayed again. In one embodiment, the receipt module 208 deletes the media file and the media message a set time after the file is displayed. In one embodiment, the receipt module 208 prevents the user of the client device 102 from saving, printing, copying, or forwarding the media file and the media message.

The sharing module 210 shares device parameters of the client device 102 executing the messaging module 104. In one embodiment, the sharing module 210 automatically shares the device parameters of the client device 102 with the messaging system 106. In another embodiment, the sharing module 210 shares the device parameters with the messaging system 106 only if the user of the client device 102 elects to share the device parameters.

In one embodiment, when the messaging module 104 is launched by the user of the client device 102, the sharing module 210 communicates with the messaging system 106 to determine whether the device parameters that the messaging system 106 has stored for the user are different than the current device parameters of the client device 102. If parameters have changed, the sharing module 210 provides updated information to the messaging system 106 for those parameters that have changed. Parameters may change, for example, if the user changes client devices 102, such as the user purchasing a new client device 102 (e.g., a new mobile phone) or the user launches the messaging module 104 on different client devices 102 of the user (e.g., launching the messaging module 104 on a mobile phone and later launching the messaging module 104 on a tablet). Device parameters may also change based on changes in network conditions.

The sharing module 210 periodically (e.g., every two hours) checks whether the parameters of the client device executing the messaging module 104 have changed. If parameters have changed, the sharing module 210 provides updated parameters to the messaging system 106. In one embodiment, the sharing module 210 periodically checks changes for certain device parameters (e.g., network parameters). Other parameters are only checked when the messaging module 104 is launched (e.g., resolution parameters).

In one embodiment, the device parameters shared with the messaging system 106 may be modified by the user of the client device 102. For example, even if the client device 102 is capable of displaying high resolution media files, the user may request that the sharing module 210 indicate to the messaging system 106 that the client device 102 can only display low resolution media files because the user wants to limit the size of files exchanged.

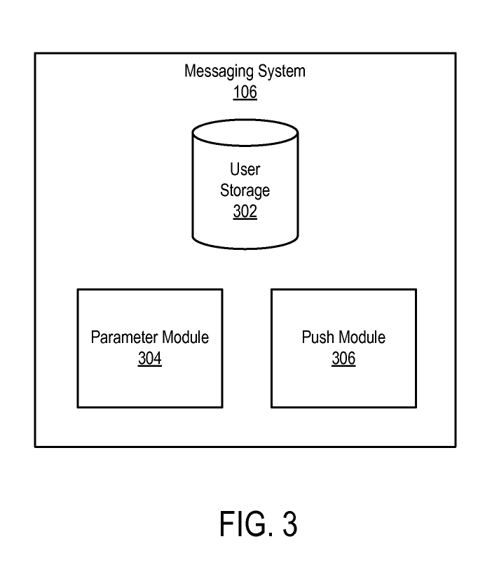

FIG. 3 is a block diagram illustrating modules operating within the messaging system 106. The messaging module 104 shown in FIG. 3 includes a user storage 302, a parameter module 304, and a push module 306. In other embodiments, the messaging system 108 may include additional, fewer, or different components for various applications. Conventional components such as network interfaces, security functions, load balancers, failover servers, management and network operations consoles, and the like are not shown so as to not obscure the details of the system architecture.

The user storage 302 stores information associated with users of the messaging system 106. If a user shares device parameters of the user's client device 102 with the messaging system 106, the user storage 302 stores the device parameters. In one embodiment, for each user, the user storage 302 stores contact information associated with the user, information indicating the contacts of the user, and indicators as to which contacts are sharing their respective device parameters with the user. Further, for each user, the user storage 302 may also store criteria provided by the user as to whether the messaging system 106 may share the user's device parameters. The criteria may be one or more of the following: share with any other user that adds the user as a contact, share with users that have a certain type of relationship with the user, or share with specific users identified by the user.

The parameter module 304 manages device parameters stored by the user storage 302. When the messaging system 106 receives device parameters of a user's client device 102, the parameter module 304 determines whether the user storage 302 already includes device parameters for the user. If the user storage 302 does not include device parameters for the user, the parameter module 304 stores the received parameters in the user storage 302 as the device parameters of the user. On the other hand, if the user storage 302 already includes device parameters for the user, the parameter module 304 determines whether the received parameters are different from the device parameters currently stored in the user storage 302 for the user. If one or more device parameters are different, the parameter module 304 updates the stored parameters with the received parameters.

The push module 306 provides updated device parameters to client devices 102. When the parameter module 304 updates the device parameters stored in the user storage 302 for a user, the push module 306 identifies based on the information stored in the user storage 302 which users are storing the user's device parameters which are now outdated. For each user identified, the push module 306 sends the updated device parameters to the user's client device 102 for storage.

The push module 306 also processes requests from users for device parameters of other users. This type of request may be received by the messaging system 106 from a user's client device 102, for example, when the user adds another user as a contact or may be sent periodically by the client device 102. In one embodiment, when the messaging system 106 receives a request from a user's client device 102 for the device parameters of another user, the push module 306 automatically sends the requested device parameters if they are included in the user storage 302. In another embodiment, when the messaging system 106 receives a request from a user for the device parameters of another user, the push module 306 determines whether criteria provided by the other user for sharing its device parameters are satisfied (e.g., if the requesting user has a certain type of relationship with the other user or if the requesting user was identified by the other user as someone with whom the parameters can be shared). If the criteria are satisfied, the push module 306 retrieves the requested device parameters from the user storage 302 and sends them to the client device 102 of the requesting user. Alternatively, if the criteria are not satisfied, the push module 306 rejects the request.

### Process

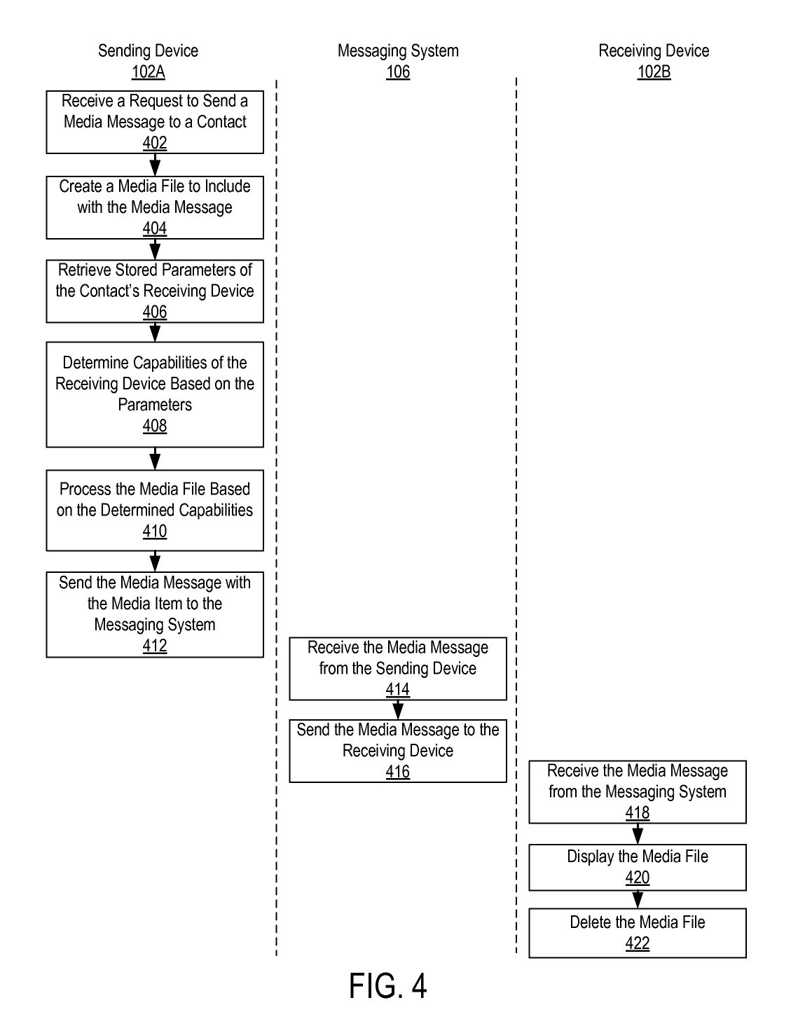

FIG. 4 is a diagram illustrating operations performed by a client device 102A (referred to as “sending device 102A”), the messaging system 106, and a client device 102B (referred to as “receiving device 102B”) when sending a media message from the sending device 102A to the receiving device 102B. Those of skill in the art will recognize that other embodiments can perform the steps of FIG. 4 in different orders. Moreover, other embodiments can include different and/or additional steps than the ones described herein.

Assume for purposes of this example, that the user operating the receiving device 102B is a contact of the user operating the sending device 102A. Additionally, assume that the sending device 102A locally stores device parameters of the receiving device 102B.

The sending device 102A receives 402 a request to send a media message to the contact. The sending device 102A creates 404 a media file to include with the media message. The sending device 102A retrieves 406 the stored device parameters of the receiving device 102B. Based on the device parameters, the sending device 102 determines 408 the capabilities of the receiving device 102B for displaying the media file. The sending device 102A processes 410 the created media file to reduce the size of the media file based on the maximum capabilities of the receiving device 102B.

The sending device 102A sends 412 the media message with the processed media item to the messaging system 106. The messaging system 106 receives 414 the media message from the sending device 102A. The messaging system 106 sends 416 the media message to the receiving device 102B.

The receiving device 102B receives 418 the media message from the messaging system 106. The receiving device 102B displays 420 the media file. The receiving device 102B deletes 422 the media file and the media message, for example, after the user of the receiving device 102B is done viewing the media file or a set time after the media file is viewed.

### Summary

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer program product comprising a non-transitory computer-readable storage medium containing computer program code for:
storing, by a sending device for each of a plurality of contacts of a user, one or more device parameters of a receiving device operated by the contact, the device parameters describing a maximum capability of the receiving device to reproduce media content;
receiving, by the sending device from the user, a request to send a media message to a selected contact from the plurality of contacts;
identifying, by the sending device from the stored device parameters, the stored device parameters of the receiving device associated with the selected contact;
creating, by the sending device, a media file to include with the media message;
processing the media file by the sending device, the processed media file reducing a size of the media file based on the maximum capability of the receiving device to reproduce media content as described by the identified device parameters of the receiving device; and
sending the media message with the processed media file from the sending device for receipt by the receiving device.

2. The computer program product of claim 1, wherein processing the media file comprises processing the media file to not exceed the maximum capability of the receiving device to reproduce media content.

3. The computer program product of claim 1, wherein the identified device parameters include a maximum pixel resolution of the receiving device and processing the media file comprises converting the media file from a created pixel resolution to a current pixel resolution, the current pixel resolution equal to or lower than the maximum pixel resolution and the maximum pixel resolution lower than the created pixel resolution.

4. The computer program product of claim 1, wherein identified device parameters include a display size of the receiving device and processing the media file comprises downscaling the media file based on the display size.

5. The computer program product of claim 1, wherein the computer program code further for:
responsive to device parameters changing for a contact from the plurality of contacts, automatically receiving from a messaging system current device parameters for the contact; and
updating the stored device parameters for the contact based on the received current device parameters.

6. The computer program product of claim 1, wherein the plurality of contacts for which the sending device stores device parameters are contacts that have one or more types of relationships with the user in a social networking system.

7. The computer program product of claim 1, wherein the plurality of contacts for which the sending device stores device parameters are contacts with which the user communicates more than a threshold number of times per a time period.

8. The computer program product of claim 1, wherein sending the media message comprises sending the media message for the receiving device that automatically deletes the media message and the processed media file responsive to the selected contact viewing the processed media file.

9. The computer program product of claim 1, wherein the computer program code further for:
identifying device parameters of the sending device; and
sending the device parameters of the sending device to a messaging system, wherein the messaging system shares the resolution parameters of the sending device with additional users.

10. The computer program product of claim 9, wherein the additional users with whom the resolution parameters are shared are identified by the user of the sending device.

11. A computer program product comprising a non-transitory computer-readable storage medium containing computer program code for:
receiving, by a sending device from a first user, a request to send a message to a second user;
identifying, by the sending device, a media file to include with the message;
identifying, by the sending device, one or more device parameters of a receiving device associated with the second user;
processing the media file by the sending device, the processed media file reducing a size of the media file based on the identified device parameters; and
sending the media message with the processed media file from the sending device for receipt by the receiving device.

12. The computer program product of claim 11, wherein the identified device parameters describe a maximum capability of the receiving device to reproduce media content and processing the media file comprises processing the media file to not exceed the maximum capability of the receiving device.

13. The computer program product of claim 11, wherein the identified device parameters include resolution parameters of a display of the receiving device, the resolution parameters indicating capabilities of the display for displaying media content.

13. The computer program product of claim 11, wherein the identified device parameters include network parameters of one or more networks to which the receiving device is connected, the network parameters describing a capability of the receiving device to receive media content.

14. The computer program product of claim 11, wherein the identified device parameters include a maximum pixel resolution of the receiving device and processing the media file comprises converting the media file from a created pixel resolution to a current pixel resolution, the current pixel resolution equal to or lower than the maximum pixel resolution and the maximum pixel resolution lower than the created pixel resolution.

15. The computer program product of claim 11, wherein identified device parameters include a display size of the receiving device and processing the media file comprises downscaling the media file based on the display size.

16. The computer program product of claim 11, wherein the computer program code further for:
responsive to one or more of the device parameters changing, automatically receiving from a messaging system current resolution parameters for the second user; and
storing the current resolution parameters for the second user.

17. The computer program product of claim 11, wherein the sending device stores the device parameters of the receiving device based on the second user having one or more types of relationships with the first user in a social networking system.

18. A system comprising:
one or more computer processors; and
a non-transitory computer-readable storage medium containing computer program code executed by the one or more computer processors for:
receiving, from a first user, a request to send a message to a second user;
identifying a media file to include with the message;
identifying one or more device parameters of a receiving device associated with the second user;
processing the media file, the processed media file reducing a size of the media file based on the identified device parameters; and
sending the media message with the processed media file for receipt by the receiving device.

19. The system of claim 18, wherein the identified device parameters describe a maximum capability of the receiving device to reproduce media content and processing the media file comprises processing the media file to not exceed the maximum capability of the receiving device.

20. The system of claim 18, wherein the identified device parameters include resolution parameters of a display of the receiving device, the resolution parameters indicating capabilities of the display for displaying media content.
